(19) United States
(12) Patent Application Publication
(10) Pub. No.: US 2026/0178973 A1
(43) Pub. Date: Jun. 25, 2026

(54) METHOD AND ELECTRONIC DEVICE FOR LEARNING MULTIMODAL MODEL

(71) Applicant: Sionic AI Inc., Seoul (KR)

(72) Inventors: Dokyoon Yoon, Seoul (KR); Youngsook Song, Seoul (KR); Woomyoung Park, Seoul (KR)

(21) Appl. No.: 19/212,858

(22) Filed: May 20, 2025

(30) Foreign Application Priority Data
Dec. 20, 2024 (KR) 10-2024-0192809

(51) Int. Cl. G06N 20/00

(52) U.S. Cl. CPC G06N 20/00

(57) ABSTRACT

A method of training a multimodal model, performed by at least one processor, includes acquiring an existing model, which is a pretrained multimodal model, obtaining a training dataset for training a multimodal model, and generating a new model by training the existing model based on the training dataset, wherein the training dataset includes true response data and false response data.

### CROSS-REFERENCE TO RELATED APPLICATION

This application claims priority to Korean Patent Application No. 10-2024-0192809, filed in the Korean Intellectual Property Office on Dec. 20, 2024, the entire contents of which are hereby incorporated by reference.

### BACKGROUND

### Field

The present disclosure relates to a method and an electronic device for training a multimodal model.

### Description of Related Art

In the field of natural language processing technology, a technique has been developed to optimize the performance of a model to meet user needs by using an LLM (large language model) as a base. In addition, as LLM models have come to process multimodality data, there is an increasing variety of needs to train a task for extracting specific information from a specific image.

However, in the case of a multimodal model, there is a problem that the model is trained only on global data (information covering the entire context or big picture of the data, e.g., an overall composition of the image or an overall style or theme of text), causing it to possibly miss detailed information on local data (specific positions or detailed information in text, images, etc., e.g., a specific object in an image or a specific word in text).

Moreover, even if such a multimodal model with this problem is trained again, not only a massive training dataset and training resources are required, but also, even if massive training data is used, the model is still trained only on global data, making it difficult to implement the function desired by the trainer.

Accordingly, there is a need to develop a technique of generating a new model optimized for a specific function from an existing multimodal model.

### SUMMARY

The present disclosure provides a method and an electronic device for training a multimodal model to solve the above problems.

The present disclosure may be implemented in various ways, including methods, devices (systems), and/or non-transitory computer-readable recording media storing computer-readable instructions.

According to an example of the present disclosure, a method of training a multimodal model, performed by at least one processor, may include acquiring an existing model, which is a pretrained multimodal model, obtaining a training dataset for training a multimodal model, and generating a new model by training the existing model based on the training dataset, wherein the training dataset may include true response data and false response data.

In some implementations, the false response data included in the training dataset is generated by changing at least a portion of data in the true response data.

In some implementations, the true response data included in the training dataset is generated by revising at least a portion of the false response data.

In some implementations, generating the new model is performed by using a loss function configured to suppress generation of the false response data for input data and increase generation of the true response data for the input data.

In some implementations, the loss function is configured to take an output of a reference model as an anchor point based on the reference model.

In some implementations, the loss function is configured to calculate a loss value based on an output value of each of the reference model and the existing model for the true response data, and an output value of each of the reference model and the existing model for the false response data.

In some implementations, the training dataset further may include location information indicating a specific position of response data that is a target of training.

In some implementations, the location information is expressed by inserting a special token for indicating a specific position within the response data.

In some implementations, generating the new model may include preventing parameters of the existing model from being updated, with respect to data other than data indicated by the location information, in a process of training the existing model using a loss value.

In some implementations, a non-transitory computer-readable recording medium storing computer-readable instructions may be provided. The instructions, when executed by at least one processor, may cause the at least one processor to acquire an existing model, which is a pretrained multimodal model, obtain a training dataset for training a multimodal model, wherein the training dataset includes true response data and false response data, and generate a new model by training the existing model based on the training dataset.

In some implementations, an electronic device may include a memory, and at least one processor connected to the memory and configured to execute computer-readable instructions stored in the memory, wherein the at least one processor is configured to acquire an existing model, which is a pretrained multimodal model, obtain a training dataset for training a multimodal model, wherein the training dataset includes true response data and false response data, and generate a new model by training the existing model based on the training dataset.

In some implementations, the at least one processor is configured to generate the new model by using a loss function that suppresses generation of the false response data for input data and increases generation of the true response data for the input data.

In some implementations, the at least one processor is configured not to update parameters of the existing model with respect to data other than the data indicated by the location information in a process of training the existing model using a loss value.

According to one or more aspects of the present disclosure, by carrying out additional training on local data rather than global data with respect to the existing model, which is a multimodal model, and generating a new model, it is possible to support the creation of a multimodal model more optimized for a specific function.

In addition, according to one or more aspects of the present disclosure, by training only specific data that is the target of training through a masking technique, it is possible to prevent overfitting and errors, and to train the model more effectively.

The effects of the present disclosure are not limited to those mentioned above, and other effects that are not mentioned will be clearly understood by those of ordinary skill in the art (referred to as “one of ordinary skill in the art”) from the descriptions of the claims.

### BRIEF DESCRIPTION OF THE DRAWINGS

Embodiment(s) of the present disclosure will be described below with reference to the attached drawings. Here, similar reference numerals denote similar elements, but are not limited thereto.

FIG. 1 illustrates an electronic device for generating a multimodal model.

FIG. 2 is a schematic diagram illustrating a configuration in which an information processing system is connected so as to be in communication with a plurality of user terminals in relation to data processing.

FIG. 3 is a block diagram illustrating internal configurations of a user terminal and an information processing system.

FIG. 4 is a conceptual diagram illustrating differences in training methods when generating a new model by training an existing model.

FIG. 5 is a conceptual diagram illustrating a training method in generating a new model by training an existing model.

FIG. 6 illustrates, by way of example, multimodal data including true response data and multimodal data including false response data.

FIG. 7 is a diagram illustrating, by way of example, normal data and abnormal data.

FIG. 8 is a diagram for explaining a method of generating a multimodal model.

FIG. 9 is a diagram for explaining a method of generating a multimodal model.

### DETAILED DESCRIPTION

Hereinafter, example details for the practice of the present disclosure will be described in detail with reference to the accompanying drawings. However, in the following description, detailed descriptions of well-known functions or configurations will be omitted if it may make the subject matter of the present disclosure rather unclear.

In the accompanying drawings, the same or corresponding components are assigned the same reference numerals. In addition, in the following description of various examples, duplicate descriptions of the same or corresponding components may be omitted. However, even if descriptions of components are omitted, it is not intended that such components are not included in any example.

Advantages and features of the disclosed examples and methods of accomplishing the same will be apparent by referring to examples described below in connection with the accompanying drawings. However, the present disclosure is not limited to the examples disclosed below, and may be implemented in various forms different from each other, and the examples are merely provided to make the present disclosure complete, and to fully disclose the scope of the disclosure to those skilled in the art to which the present disclosure pertains.

The terms used herein will be briefly described prior to describing the disclosed example(s) in detail. The terms used herein have been selected as general terms which are widely used at present in consideration of the functions of the present disclosure, and this may be altered according to the intent of an operator skilled in the art, related practice, or introduction of new technology. In addition, in specific cases, certain terms may be arbitrarily selected by the applicant, and the meaning of the terms will be described in detail in a corresponding description of the example(s). Accordingly, the terms used in this disclosure should be defined based on the meaning of the term and the overall content of the present disclosure, rather than simply the name of the term.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it is intended as meaning that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

A “module” or “unit” may be implemented as a processor and a memory, or may be implemented as a circuit (circuitry). Terms such as circuit and circuitry may refer to circuits in hardware, but may also refer to circuits in software. The “processor” should be interpreted broadly to encompass a general-purpose processor, a central processing unit (CPU), a microprocessor, a digital signal processor (DSP), a neural processing unit (NPU), a controller, a microcontroller, a state machine, etc. Under some circumstances, the “processor” may refer to an application-specific integrated circuit (ASIC), a programmable logic device (PLD), a field-programmable gate array (FPGA), etc. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. The memory is said to be in electronic communication with a processor if the processor can read information from and/or write information to the memory. The memory integrated with the processor is in electronic communication with the processor.

In addition, terms such as first, second, A, B, (a), (b), etc. used in the following examples are only used to distinguish certain components from other components, and the nature, sequence, order, etc. of the components are not limited by the terms.

In addition, in the following examples, if a certain component is stated as being “connected,” “combined” or “coupled” to another component, it is to be understood that there may be yet another intervening component “connected,” “combined” or “coupled” between the two components, although the two components may also be directly connected or coupled to each other.

In addition, as used in the following examples, “comprise” and/or “comprising” does not foreclose the presence or addition of one or more other elements, steps, operations, and/or devices in addition to the recited elements, steps, operations, or devices.

Hereinafter, various examples of the present disclosure will be described in detail with reference to the accompanying drawings.

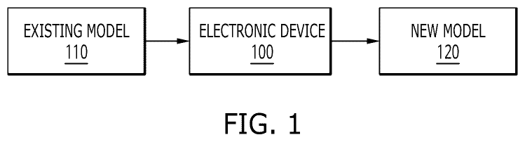

FIG. 1 illustrates, by way of example, an electronic device 100 for generating a multimodal model. Referring to FIG. 1, electronic device 100 may generate a new model 120 by updating at least one parameter included in an existing model 110 through training based on a training dataset for training a multimodal model.

Electronic device 100 for training a multimodal model may include a memory and at least one processor. However, the configuration of electronic device 100 is not limited thereto. The electronic device 100 may further include at least one other component in addition to the above-mentioned components. For example, electronic device 100 may further include a communication circuit (or communication module) for communication with an external electronic device.

The processor may be connected to the memory and may be configured to execute at least one computer-readable program stored in the memory. For example, the processor may execute software (or a program) to control at least one other component (e.g., hardware or software components) of electronic device 100 that is connected to the processor, and may perform various data processes or operations. According to an example, as at least part of data processing or operations, the processor may load instructions or data received from another component (e.g., a communication circuit) into volatile memory, process instructions or data stored in the volatile memory, and store resulting data in nonvolatile memory.

The memory may store various data used by at least one component (e.g., the processor) of electronic device 100. The data may include, for example, input or output data regarding software (or programs) and related instructions. The memory may include volatile memory or nonvolatile memory.

At least one program executed by the processor may include instructions associated with training and generating a multimodal model. Below, for ease of explanation, it is described as if the processor performs a certain function. It should be understood, however, that the function performed by the processor is essentially based on the processor executing at least one program stored in the memory.

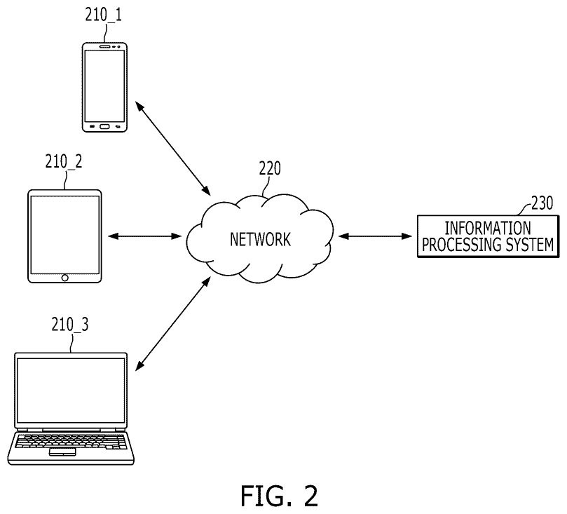

FIG. 2 is a schematic diagram illustrating a configuration in which an information processing system 230 is connected so as to be in communication with a plurality of user terminals 210_1, 210_2, 210_3 in relation to data processing. Information processing system 230 may include a system(s) capable of providing a data processing service (for example, a multimodal model-based service). In an example, information processing system 230 may include one or more server devices and/or databases, or one or more distributed computing devices and/or distributed databases based on a cloud computing service, which may store, provide, and execute computer-executable programs (e.g., a downloadable application) and data related to data processing services. For example, information processing system 230 may include separate system(s) (for example, servers) for data processing services.

A data processing service, etc., provided by information processing system 230 may be provided to users through a data processing application, or and a web browser application installed on each of the plurality of user terminals 210_1, 210_2, 210_3.

Each of the plurality of user terminals 210_1, 2102, 210_3 may communicate with information processing system 230 via network 220. Network 220 may be configured to enable communication between the plurality of user terminals 210_1, 210_2, 210_3 and information processing system 230. Depending on the installation environment, network 220 may be composed of, for example, a wired network such as Ethernet, a wired home network (Power Line Communication), telephone line communication devices, and RS-serial communication; a wireless network such as a mobile communication network, WLAN (Wireless LAN), Wi-Fi, Bluetooth, ZigBee, etc.; or a combination thereof. The communication method is not limited, and near-field wireless communication between user terminals 210_1, 210_2, 210_3 may be included as well as communication via a communication network (e.g., a mobile communication network, wired internet, wireless internet, broadcasting network, satellite network, etc.) included in network 220.

For example, the plurality of user terminals 210_1, 210_2, 210_3 may transmit a data processing request and/or a command associated with a user request for data processing to information processing system 230 via network 220, and information processing system 230 may receive it.

In FIG. 2, a mobile phone terminal 210_1, a tablet terminal 210_2, and a PC terminal 210_3 are shown as examples of user terminals, but the present disclosure is not limited thereto. User terminals 210_1, 210_2, 2103 may be any computing devices capable of wired and/or wireless communication in which a data processing application, etc., can be installed and executed. For example, user terminals may include a smartphone, a mobile phone, a navigation device, a computer, a laptop, a terminal for digital broadcasting, a PDA (Personal Digital Assistant), a PMP (Portable Multimedia Player), a tablet PC, a game console, a wearable device, an IoT (internet of things) device, a VR (virtual reality) device, an AR (augmented reality) device, and so on. Although FIG. 2 shows three user terminals 210_1, 210_2, 210_3 communicating with information processing system 230 via network 220, the present disclosure is not limited thereto, and a different number of user terminals may be configured to communicate with information processing system 230 via network 220.

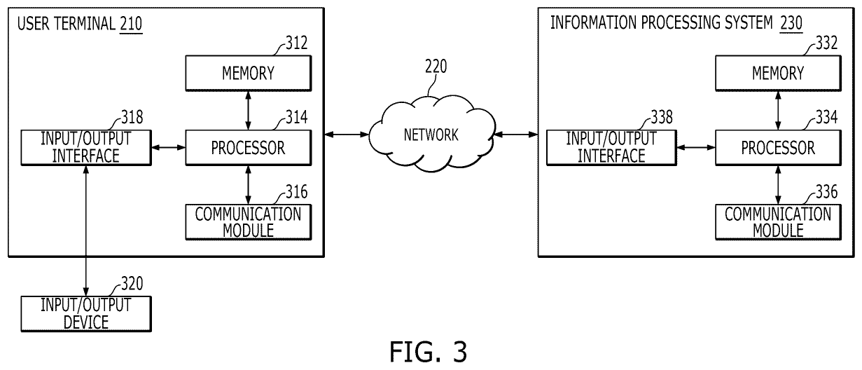

FIG. 3 is a block diagram illustrating internal configurations of user terminal 210 and information processing system 230. User terminal 210 may refer to any computing device capable of running a data processing application, etc., and capable of wired/wireless communication, for example, including a mobile phone terminal 210_1, a tablet terminal 210_2, a PC terminal 2103, etc., in FIG. 2. As shown, user terminal 210 may include a memory 312, a processor 314, a communication module 316, and an input/output interface 318. Similarly, information processing system 230 may include a memory 332, a processor 334, a communication module 336, and an input/output interface 338. As shown in FIG. 3, user terminal 210 and information processing system 230 may communicate information and/or data with each other via network 220 using communication modules 316 and 336, respectively. In addition, input/output device 320 may input to or output from user terminal 210 information and/or data generated by user terminal 210 via input/output interface 318.

Memories 312 and 332 may include non-transitory computer-readable recording media of any kind. According to an example, memories 312 and 332 may include a permanent mass storage device such as a ROM (read only memory), a disk drive, an SSD (solid state drive), a flash memory, etc. As another example, a permanent mass storage device such as ROM, SSD, a flash memory, a disk drive, etc., may be included in the user terminal 210 or information processing system 230 as a separate permanent storage device distinct from the memory. Further, memories 312 and 332 may store an operating system and at least one program code (for example, code for an application associated with a data processing service, etc.).

These software components may be loaded from a separate computer-readable recording medium distinct from memories 312 and 332. Such a separate computer-readable recording medium may include, for example, a floppy drive, a disk, a tape, a DVD/CD-ROM drive, a memory card, etc., which can be directly connected to user terminal 210 or information processing system 230. As another example, software components may be loaded into memories 312 and 332 through communication modules 316 and 336, rather than via a computer-readable recording medium. For example, at least one program may be loaded into memories 312 and 332 by a computer program (for example, an application associated with data processing services, etc.) that is installed through files provided by developers or by a file distribution system distributing installation files of the application via network 220.

Processors 314 and 334 may be configured to process instructions of a computer program by performing basic arithmetic, logic, and input/output operations. The instructions may be provided to processors 314 and 334 from memories 312 and 332 or communication modules 316 and 336. For example, processors 314 and 334 may be configured to execute commands received in accordance with program code stored in memories 312 and 332.

Communication modules 316 and 336 may provide configurations or functions for user terminal 210 and information processing system 230 to communicate with each other via network 220, and may provide configurations or functions for user terminal 210 and/or information processing system 230 to communicate with another user terminal or another system (e.g., a separate cloud system). For example, a request or data (for example, a data processing request or data, etc.) generated by processor 314 of user terminal 210 according to program code stored in a storage device such as memory 312 may be delivered to information processing system 230 via network 220 under the control of communication module 316. Conversely, control signals or commands provided under the control of processor 334 of information processing system 230 may be received by user terminal 210 via communication module 336 and network 220 through communication module 316 of user terminal 210.

Input/output interface 318 may serve as a means of interfacing with input/output device 320. As an example, input devices may include a camera containing an audio sensor and/or an image sensor, a keyboard, a microphone, a mouse, etc., and output devices may include a display, a speaker, a haptic feedback device, etc. As another example, input/output interface 318 may serve as a means to interface with a device that integrates input and output configurations or functions into one, such as a touchscreen. In FIG. 3, input/output device 320 is shown as not being included in user terminal 210, but the present disclosure is not limited thereto, and it may be configured as a single device with user terminal 210. Also, input/output interface 338 of information processing system 230 may serve as a means to interface with a device (not shown) for input or output that may be connected to or included in information processing system 230. In FIG. 3, input/output interfaces 318 and 338 are shown as components separate from processors 314 and 334, but the present disclosure is not limited thereto, and input/output interfaces 318 and 338 may be included in processors 314 and 334.

User terminal 210 and information processing system 230 may include more components than those of FIG. 3. However, there is no need to explicitly show most conventional technical components. In an example, user terminal 210 may be implemented to include at least a portion of the above-mentioned input/output device(s) 320. In addition, user terminal 210 may further include other components such as a transceiver, a GPS (Global Positioning System) module, a camera, various sensors, or a database. For example, if user terminal 210 is a smartphone, it may include components commonly contained in smartphones, such as an accelerometer, a gyro sensor, a microphone module, a camera module, various physical buttons, buttons via a touch panel, input/output ports, a vibrator for vibration, and so forth.

The processor 314 of user terminal 210 may be configured to operate a data processing application or web browser application that provides a data processing service. At this time, program code associated with the application may be loaded into memory 312 of user terminal 210. While the application is operating, processor 314 of user terminal 210 may receive information and/or data provided from input/output device 320 via input/output interface 318 or from information processing system 230 via communication module 316, process the received information and/or data, and store it in memory 312. This information and/or data may also be provided to information processing system 230 via communication module 316.

While a data processing application is operating, processor 314 may receive, via input/output interface 318, voice data, text, images, video, etc., which are input or selected through input devices such as a touchscreen, keyboard, a camera including an audio sensor and/or an image sensor, or a microphone, and may store the received voice data, text, images and/or video, etc., in memory 312 or provide them to information processing system 230 via communication module 316 and network 220. The processor 314 may receive user inputs entered via an input device and provide data/requests corresponding to the received user inputs to information processing system 230 via network 220 and communication module 316.

Processor 314 of user terminal 210 may transmit information and/or data to input/output device 320 via input/output interface 318 to output it. For example, processor 314 of user terminal 210 may output processed information and/or data through output devices 320 such as a device capable of display output (e.g., a touchscreen, a display), a device capable of voice output (e.g., a speaker), etc.

Processor 334 of information processing system 230 may be configured to manage, process, and/or store information and/or data received from a plurality of user terminals 210 and/or a plurality of external systems. The information and/or data processed by processor 334 may be provided to user terminal 210 via communication module 336 and network 220.

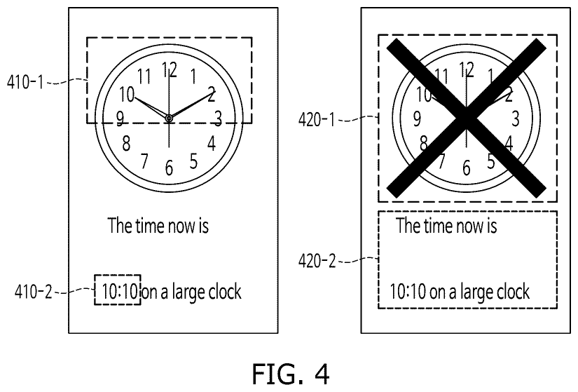

FIG. 4 is a conceptual diagram illustrating differences in training methods when generating a new model by training an existing model. Referring to FIG. 4, in the case of a conventional LLM model, there was a tendency to reference global data including all the unnecessary information for generating an output, such as training the entire watch image area 420-1 to output the current time or training the entire sentence 420-2. Meanwhile, according to the training method of the present disclosure, the model may be optimized mainly for local data that are absolutely necessary to generate an output by training the hour hand and minute hand area 410-1 used to check the time and the text token 410-2 indicating the time.

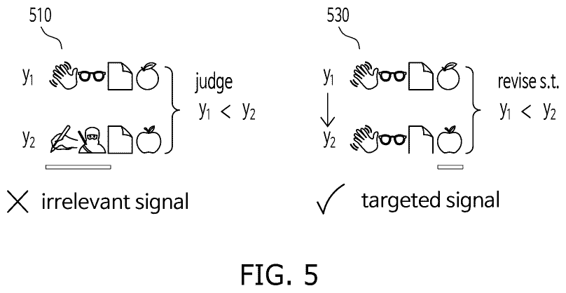

FIG. 5 is a conceptual diagram illustrating a training method in generating a new model by training an existing model. For example, suppose that the new model must train the sentence “Apples are better than tangerines.” In the case of a conventional dataset, overfitting may occur, or errors may arise where training is conducted based on data unrelated to apples and tangerines, owing to irrelevant differences (for instance, hands and glasses vs. a pen and a ninja) that have nothing to do with the portion actually requiring training. Meanwhile, in the training method of the present disclosure, there is an effect that it is possible to generate an optimized new model by indicating the specific data that is the target of training and applying a masking method so that no training is performed on any other data.

In the present disclosure, the term “true data” (ground truth data) may refer to output data intended to be generated for input data when electronic device 100 generates a new model 120 by updating an existing model 110, and the term “false data” (also referred to as false data or hallucination data) may refer to output data intended to be suppressed from being generated for input data when electronic device 100 generates a new model 120 by updating an existing model 110.

The neural network model according to the present disclosure may be a multimodal model that processes multimodal data and generates output data.

A “multimodal model” refers to an artificial neural network model that can process and train various types of data simultaneously, recognize interactions or context among the data, and generate outputs therefrom.

“Multimodal data,” used to train a multimodal model according to the present disclosure, refers to data composed of different types of information, for example, data including different types of data such as image data, text data, audio data, and video data that each have different characteristics.

A multimodal model that processes multimodal data uses separate encoders for each type of data, and may generate a final output by fusing the features of each data extracted through the encoders.

For example, in the case of text data included in multimodal data, tokenization of the text data into certain units and embedding each token into vector values that a computer can recognize and process may be performed. As an example, a byte pair encoding (BPE) method may be used for tokenization. Generally, BPE is a technique that creates a vocabulary by dividing words into characters or Unicode units, and generates tokens by merging consecutive characters or Unicodes based on their frequency of appearance in the vocabulary. The embedding operation, which converts each token generated through tokenization into an embedding vector, may be performed by various techniques such as Glove, FastText, or Word2Vec. Also, for image data included in multimodal data, an encoder model such as CNN (Convolutional Neural Network) or ViT (Vision Transformer) may extract image features and generate an embedding vector as a tensor or vector having a certain dimension.

When embedding vectors each including features for the plurality of data included in the multimodal data have been generated, it is possible to fuse the features by concatenating multiple embedding vectors, matching their dimensions and adding them, etc.

A multimodal model may generate intermediate data for making a final output by including a fusion layer that extracts features through encoder models for each of the plurality of input data as described above and fuses those features.

According to the present disclosure, electronic device 100 may generate true response data y_w and false response data y_l for input data x, which consists of image data and query data that is text data.

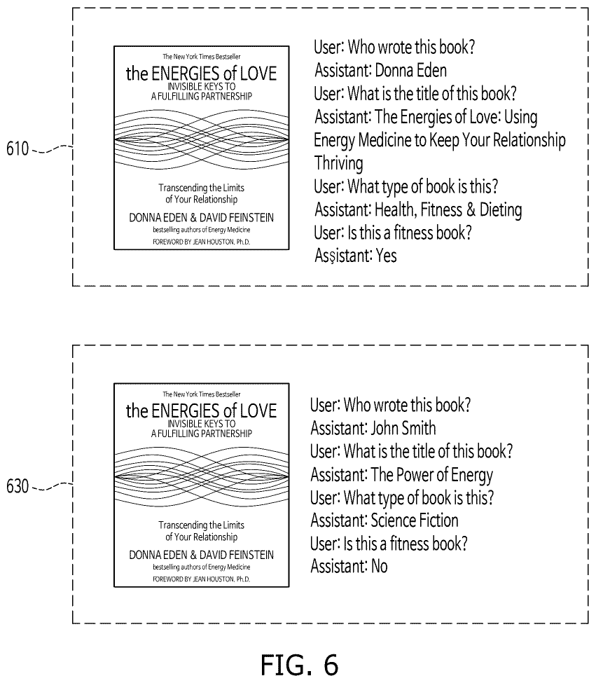

FIG. 6 illustrates, by way of example, multimodal data 610 including true response data and multimodal data 620 including false response data.

Referring to FIG. 6, for the query data “Who wrote this book?” input together with image data, the true response data may be “Donna Eden,” and the false response data may be “John Smith.” Also, for the query data “What is the title of this book?,” the true response data may be “The Energies of Love: Using Energy Medicine to Keep Your Relationship Thriving,” and the false response data may be “The Power of Energy.” Further, for the query data “What type of book is this?,” the true response data may be “Health, Fitness & Dieting,” and the false response data may be “Science Fiction.” Moreover, for the query data “Is this a fitness book?,” the true response data may be “Yes,” and the false response data may be “No.”

According to the present disclosure, electronic device 100 may create a pair (tuple) of false response data and true response data by revising at least a portion of the false response data to generate true response data or by changing (hallucination) at least a portion of the true response data to generate false response data.

For example, suppose the image data included in the multimodal data is a photo of a cat with white fur. In this case, predetermined false response data may be something like “This photo is about a puppy. The puppy in the photo has brown fur.” Then electronic device 100 may acquire revised true response data “This photo is about a cat. The cat in the photo has white fur.” based on external user input. Conversely, when predetermined true response data is “This photo is about a cat. The cat in the photo has white fur,” electronic device 100 may generate false response data such as “This photo is about a puppy. The puppy in the photo has brown fur.”

In the present disclosure, the process of generating false response data by modifying at least a portion of the true response data may be performed by an external user or may be carried out as a result of computation by a separately trained natural language processing model that replaces certain text tokens.

Electronic device 100 may generate a new model by training the existing model, using input data x, true response data y_w, and false response data y_l, through a loss function such as in Equation 1 below.

$$ℒ ( x , {y}_{w} , {y}_{l} ; θ ) = {r}_{θ} ( x , {y}_{l} ) - {r}_{θ} ( x , {y}_{w} ) \qquad [ Equation 1 ]$$

Here, [symbol] denotes the loss function, x is the input multimodal data, y_{w} is the true response data, yₗ is the false response data, and θ is a trainable parameter. r_{θ}(x,y) is a reward function calculated based on the difference between the output value derived by the model having parameter θ for the input x and y. The reward function may be set so that the larger the difference between the model's output value for x and y, the larger the absolute value it returns.

Electronic device 100 may update the existing model and generate the new model by using a loss function further based on a reference model. Specifically, electronic device 100 may generate the new model by training the existing model to generate a better output than the reference model by using the reference model's output as an anchor point. The reference model may be a separate multimodal model trained to output similarly for the same input data as the existing model.

For example, electronic device 100 may use a loss function as in Equation 2 below.

$$ℒ ( x , {y}_{w} , {y}_{l} ; θ ) = - σ ( {r}_{θ} ( x , {y}_{w} ) - {β}_{KL , w} ) - σ ( {β}_{KL , l} - {r}_{θ} ( x , {y}_{l} ) ) \qquad [ Equation 2 ]$$

Here, [symbol] denotes the loss function, x is the input multimodal data, y_{w} is the true response data, yₗ is the false response data, θ is a trainable parameter, and r_{θ}(x,y) is a reward function calculated based on the difference between the output value derived by the model having parameter θ for the input x and y. The reward function may be set so that the larger the difference between the model's output value for x and y, the larger the absolute value it returns. Also, a may be a variable for determining the magnitude of the loss value derived by the loss function. β_{KL,w} and β_{KL,l} are KL divergence (Kullback-Leibler Divergence) terms related to the true response data and the false response data, respectively, which may be expressed by Equations 3 to 4 below, for example.

$${β}_{KL , w} = {D}_{KL} ( {π}_{θ} ( {y}_{w} \vert x ) \vert {π}_{ref} ( {y}_{w} \vert x ) ) \qquad [ Equation 3 ]$$

$${β}_{KL , l} = {D}_{KL} ( {π}_{θ} ( {y}_{l} \vert x ) \vert {π}_{ref} ( {y}_{l} \vert x ) ) \qquad [ Equation 4 ]$$

KL divergence is a term representing how similar two probability distributions are; the more similar the two distributions, the smaller its value. Also, in Equation 3, π_{θ}(y_{w}|x) represents the probability distribution that the existing model outputs the true response data y_{w} for input data x, and π_{ref}(y_{w}|x) represents the probability distribution that the reference model outputs the true response data y_{w} for input data x. Likewise, in Equation 4, π_{θ}(yₗ|x) represents the probability distribution that the existing model outputs the false response data yₗ for input data x, and π_{ref}(yₗ|x) represents the probability distribution that the reference model outputs the false response data yₗ for input data x.

By training the existing model using the loss function represented by Equations 2 to 4, electronic device 100 according to the present disclosure may prevent the model from generating output data similar to that of the reference model with a lower probability for the true response data, and may prevent the model from generating output data similar to that of the reference model with a higher probability for the false response data. Also, by training the existing model using the aforementioned KL divergence term, electronic device 100 according to the present disclosure may induce the existing model not to train data that do not require training.

According to the present disclosure, electronic device 100 may train the existing model and generate a new model by using a training dataset that includes location information indicating a specific position of response data that is a target of training. For example, suppose the image data included in multimodal data is a photo about a “cat,” and the query data is “What is this a photo of?” In this case, the true response data may be “This photo is about a cat,” and the false response data may be “This photo is about a dog.” Here, the training dataset may further include location information about a specific position containing key information.

As an example, the location information may be expressed by inserting a special token in the text data. For instance, the true response data that includes location information may be expressed as “This photo is about [CLS]cat[CLS],” or “This photo is about <<cat>>,” and the false response data that includes location information may be expressed as “This photo is about [CLS]dog[CLS],” or “This photo is about <<dog>>.”

As another example, the location information may be expressed as a masking vector of the same dimension as the text data. For instance, if the embedding vector has size L as a result of embedding the text data, the masking vector may be a binary vector of size L. Specifically, assuming the sequence length is 5 and the masking vector is [0, 0, 1, 0, 0], it may be a masking vector that activates only the third token.

According to the present disclosure, by using a response dataset that includes location information indicating a specific position of response data, electronic device 100 may prevent the parameters of the existing model from being updated (or electronic device 100 is configured not to update parameters of the existing model) with respect to data other than the data indicated by the location information. In other words, the model parameters unrelated to data that the existing model needs to train may not be subjected to further training. Through this, the present disclosure may reflect only local data that the existing model needs to train into the training process, thereby avoiding unnecessary model parameter updates or overfitting and generating a more accurate new model.

According to the present disclosure, electronic device 100 may create a training dataset for training the existing model by generating multiple pieces of training data through masking a specific position of the input data.

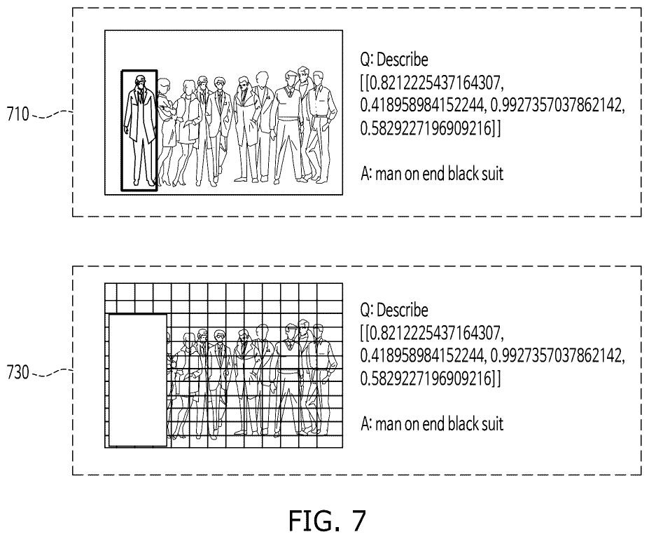

FIG. 7 illustrates, by way of example, normal data 710 and abnormal data 730. Referring to FIG. 7, assume that electronic device 100 trains a multimodal model that outputs response data, by inputting data that includes certain image data and a query data requesting an explanation of a specific position in the image.

Normal data 710 is input data that includes the original image data, in which the specific position in the image that requires explanation appears intact, and abnormal data 720 is image data in which the specific position in the image that requires explanation is masked. In this case, the same text response “man on end black suit” may be learned as true response data in normal data 710 and as false response data in abnormal data 720. By means of such a training dataset, the multimodal model being trained may learn more accurately which position of the image should be targeted to generate an output in response to an input query.

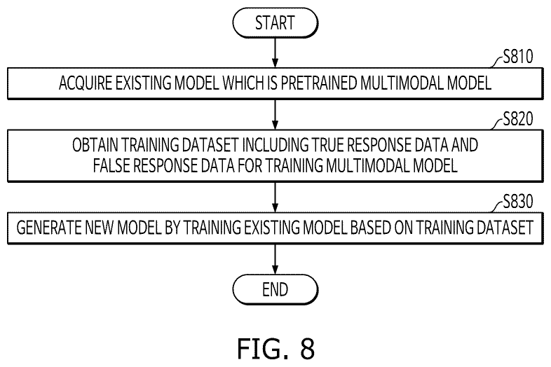

FIG. 8 is a diagram for explaining a method of generating a multimodal model.

Referring to FIG. 8, in step S810, a processor of an electronic device (e.g., electronic device 100 of FIG. 1) may acquire an existing model, which is a pretrained multimodal model. The existing model may be a model that receives an image and text at the same time and generates response data for an input query. For example, the existing model may be a model that receives a watch image and a query about the time, and generates response data describing the current time, or a model that receives a movie poster image and a query about the movie title, and outputs the name of the movie poster.

In step S820, the processor may obtain a training dataset for training a multimodal model. The training dataset may include true response data and false response data. For example, the true response data may be text data such as “The title of this movie is Parasite,” which the multimodal model should output. On the other hand, the false response data may be data obtained by replacing at least a portion of the true response data, for example, text data such as “The title of this movie is Bleak Night.”

In step S830, the processor may generate a new model by training the existing model based on the training dataset. By using a loss function that suppresses the generation of false response data to input data and increases the generation of true response data, the processor may train the existing model. At this time, the processor may backpropagate the loss value based on a loss function that simultaneously uses a tuple of false response data and true response data for the input data.

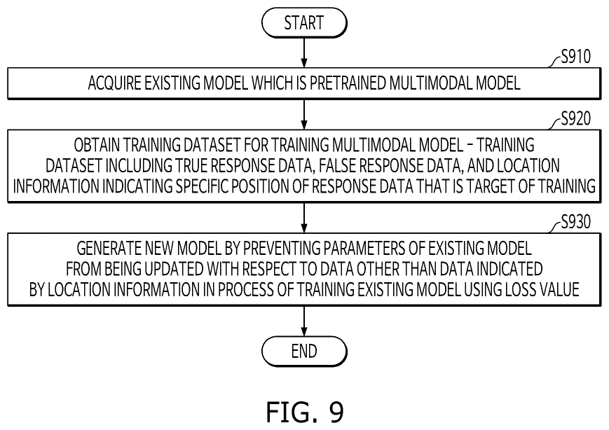

FIG. 9 is a diagram for explaining a method of generating a multimodal model.

Referring to FIG. 9, in step S910, a processor of an electronic device (e.g., electronic device 100 of FIG. 1) may acquire an existing model, which is a pretrained multimodal model. Step S910 may be performed in the same or similar manner as step S810 of FIG. 8.

In step S920, the processor may obtain a training dataset for training a multimodal model. The training dataset may include true response data, false response data, and location information indicating a specific position of the response data that is the target of training. Here, the location information may be expressed by inserting special tokens in the text data. Also, the location information may be expressed as a masking vector that has the same dimension as the text data.

In step S930, in a process of training the existing model using the loss value, the processor may generate the new model by preventing the parameters of the existing model from being updated with respect to data other than the data indicated by the location information. For example, in calculating a loss function such as softmax, the processor may assign 0 to regions that are not relevant information, so that parameters are not updated. Through this, the training method according to the present disclosure can intensively train only the specific position of the response data necessary for generating an output.

The flowchart and description above are merely examples and may be implemented differently in some examples. For example, in some examples, the order of respective steps may be changed, some steps may be repeatedly performed, some steps may be omitted, or some steps may be added.

The method described above may be provided as a computer program stored in a computer-readable recording medium for execution on a computer. The medium may be a type of medium that continuously stores a program executable by a computer, or temporarily stores the program for execution or download. In addition, the medium may be a variety of recording means or storage means having a single piece of hardware or a combination of several pieces of hardware, and is not limited to a medium that is directly connected to any computer system, and accordingly, may be present on a network in a distributed manner. An example of the medium includes a medium configured to store program instructions, including a magnetic medium such as a hard disk, a floppy disk, and a magnetic tape, an optical medium such as a CD-ROM and a DVD, a magnetic-optical medium such as a floptical disk, and a ROM, a RAM, a flash memory, etc. In addition, other examples of the medium may include an app store that distributes applications, a site that supplies or distributes various software, and a recording medium or a storage medium managed by a server.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the present disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, etc. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessible to a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessible to a computer. In addition, any connection is properly referred to as a computer-readable medium.

For example, if the software is sent from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the examples described above have been described as utilizing aspects of the currently disclosed subject matter in one or more standalone computer systems, aspects are not limited thereto, and may be implemented in conjunction with any computing environment, such as a network or distributed computing environment. Furthermore, the aspects of the subject matter in the present disclosure may be implemented in multiple processing chips or apparatus, and storage may be similarly influenced across a plurality of apparatus. Such apparatus may include PCs, network servers, and portable apparatus.

Although the present disclosure has been described in connection with some examples herein, various modifications and changes can be made without departing from the scope of the present disclosure, which can be understood by those skilled in the art to which the present disclosure pertains. In addition, such modifications and changes should be considered within the scope of the claims appended herein.

What is claimed is:

1. A method performed by an electronic device comprising at least one processor, the method comprising:
acquiring an artificial intelligence model, wherein the acquired artificial intelligence model is a pretrained multimodal model;
obtaining a training dataset for training a multimodal model, wherein the training dataset comprises true response data and false response data; and
generating, based on the training dataset, a new model by training the artificial intelligence model.

2. The method according to claim 1, wherein the false response data included in the training dataset is generated by changing at least a portion of data in the true response data.

3. The method according to claim 1, wherein the true response data included in the training dataset is generated by revising at least a portion of the false response data.

4. The method according to claim 1, wherein the generating of the new model is performed by using a loss function configured to suppress generation of the false response data for input data and increase generation of the true response data for the input data, and wherein the input data is input data for training the artificial intelligence model.

5. The method according to claim 4, wherein the loss function is configured to take an output of a reference model as an anchor point based on the reference model.

6. The method according to claim 5, wherein the loss function is configured to calculate a loss value based on:
an output value of each of the reference model and the artificial intelligence model for the true response data, and
an output value of each of the reference model and the artificial intelligence model for the false response data.

7. The method according to claim 1, wherein the training dataset further comprises location information indicating a specific position of response data that is a target of training.

8. The method according to claim 7, wherein the location information is expressed by inserting a special token for indicating a specific position within the response data.

9. The method according to claim 7, wherein the generating of the new model comprises preventing parameters of the artificial intelligence model from being updated, with respect to data other than the response data indicated by the location information, in a process of training the artificial intelligence model using a loss value.

10. A non-transitory computer-readable medium storing computer-readable instructions, wherein the computer-readable instructions, when executed by at least one processor, are configured to cause an electronic device to:
acquire an artificial intelligence model, wherein the acquired artificial intelligence model is a pretrained multimodal model;
obtain a training dataset for training a multimodal model, wherein the training dataset comprises true response data and false response data; and
generate, based on the training dataset, a new model by training the artificial intelligence model.

11. An electronic device comprising:
a memory storing computer-readable instructions; and
at least one processor connected to the memory and configured to execute the computer-readable instructions,
wherein the computer-readable instructions, when executed by the at least one process, are configured to cause the electronic device to:
acquire an artificial intelligence model, wherein the acquired artificial intelligence model is a pretrained multimodal model;
obtain a training dataset for training a multimodal model, wherein the training dataset comprises true response data and false response data; and
generate, based on the training dataset, a new model by training the artificial intelligence model.

12. The electronic device according to claim 11, wherein the computer-readable instructions, when executed by the at least one processor, are configured to cause the electronic device to generate the new model by using a loss function configured to suppress generation of the false response data for input data and increase generation of the true response data for the input data, and wherein the input data is input data for training the artificial intelligence model.

13. The electronic device according to claim 12, wherein the loss function is configured to take an output of a reference model as an anchor point based on the reference model.

14. The electronic device according to claim 11, wherein the training dataset further comprises location information indicating a specific position of response data that is a target of training.

15. The electronic device according to claim 14, wherein the computer-readable instructions, when executed by the at least one processor, are configured to cause the electronic device to skip an update of parameters of the artificial intelligence model with respect to data other than the response data indicated by the location information in a process of training the artificial intelligence model using a loss value.
